(19) United States
(12) Patent Application Publication
(10) Pub. No.: US 2023/0390727 A1
(43) Pub. Date: Dec. 7, 2023

(54) DIFFUSER-LESS NANOBUBBLE GENERATOR

(71) Applicant: Moleaer, Inc., Carson, CA (US)

(72) Inventors: Bruce Scholten, Carson, CA (US); Federico Pasini, Redondo Beach, CA (US)

(21) Appl. No.: 18/205,347

(22) Filed: Jun. 2, 2023

Related U.S. Application Data
(60) Provisional application No. 63/349,520, filed on Jun. 6, 2022.

(51) Int. Cl. B01J 19/08

(52) U.S. Cl. CPC B01J 19/088; B01J 2219/0854; B01J 2219/0809; B01J 2219/0869; B01J 2219/0877

(57) ABSTRACT

A nanobubble generator includes a pipe and an energy source. The pipe includes an external surface, an internal surface, an internal cavity through which liquid can flow, a liquid inlet, and a liquid outlet. The internal cavity is configured to create a reduced pressure zone between the liquid inlet and liquid outlet. The nanobubble generator also includes an energy source. The energy source includes (a) a power supply, a signal generator, and at least one electrical conductor configured to apply an oscillating magnetic field to the pipe, (b) a power supply and a pair of electrical conductors configured to generate an electrical arc between the two electrical conductors and apply the electrical arc to the pipe, or (c) a combination thereof. The generator creates nanobubbles in the absence of an external source of gas.

### CLAIM OF PRIORITY

This application claims priority to U.S. Patent Application Ser. No. 63/349,520, filed on Jun. 6, 2022, the contents of which are incorporated here by reference in their entirety.

### TECHNICAL FIELD

This invention relates to generating nanobubbles in a liquid carrier.

### BACKGROUND

Nanobubbles are stable in liquid carriers for extended periods of time, allowing them to be transported without coalescing in the liquid carrier. In addition, nanobubbles have an innate electrical charge due to their high internal pressure. These properties make nanobubbles useful in a variety of fields, including water treatment, plant growth, aquaculture, and sterilization.

### SUMMARY

In a first aspect, there is described a nanobubble generator that includes (a) a pipe and (b) an energy source. The pipe includes an external surface, an internal surface, an internal cavity through which liquid can flow, a liquid inlet, and a liquid outlet. The internal cavity is configured to create a reduced pressure zone between the liquid inlet and liquid outlet. The energy source includes a power supply, a signal generator, and at least one electrical conductor configured to apply an oscillating magnetic field to the pipe. The generator creates nanobubbles in the absence of an external source of gas.

In some embodiments, the electrical conductor is configured to apply the oscillating magnetic field to the reduced pressure zone. In some embodiments, the electrical conductor is configured to apply the oscillating magnetic field to a portion of the pipe upstream of the reduced pressure zone, a portion of the pipe downstream of the reduced pressure zone, or both. In some embodiments, the electrical conductor is positioned on the external surface of the pipe, whereas in other embodiments the electrical conductor is positioned on the internal surface of the pipe. The electrical conductor may include a magnetic coil, a stator, a wire, or a combination thereof. In one particular embodiment, the energy source includes at least a pair of magnetic coils (e.g., two, four, six, eight, or more than ten magnetic coils) configured to generate oscillating magnetic fields that overlap at the reduced pressure zone. In some embodiments, the magnetic coils are arranged so that the generated oscillating magnetic fields converge at the pipe, e.g., converge on the reduced pressure zone.

In a second aspect, there is described a nanobubble generator that includes (a) a pipe and (b) an energy source. The pipe includes an external surface, an internal surface, an internal cavity through which liquid can flow, a liquid inlet, and a liquid outlet. The internal cavity is configured to create a reduced pressure zone between the liquid inlet and liquid outlet. The energy source includes a power supply and a pair of electrical conductors configured to generate an electrical arc between the two electrical conductors and apply the electrical arc to the pipe. In some examples, the energy source also includes a voltage amplifier. The generator creates nanobubbles in the absence of an external source of gas.

In some embodiments of the second aspect, the electrical conductor is configured to apply the oscillating magnetic field to the reduced pressure zone. In some embodiments, the energy source is configured to apply the electrical arc to a portion of the pipe upstream of the reduced pressure zone, a portion of the pipe downstream of the reduced pressure zone, or both. In some embodiments of the second aspect, the electrical conductor is the pipe or is positioned on the external surface of the pipe, whereas in other embodiments the electrical conductor is positioned on the internal surface of the pipe.

In a third aspect, there is described a nanobubble generator that includes (a) a pipe and (b) an energy source. The pipe includes an external surface, an internal surface, an internal cavity through which liquid can flow, a liquid inlet, and a liquid outlet. The internal cavity is configured to create a reduced pressure zone between the liquid inlet and liquid outlet. The nanobubble generator further includes a first energy source and a second energy source. The first energy source includes a power supply, a signal generator, and at least one electrical conductor configured to apply an oscillating magnetic field to the pipe. The second energy source includes a power supply and a pair of electrical conductors configured to generate an electrical arc between the two electrical conductors and apply the electrical arc to the pipe. In some examples, the energy source also includes a voltage amplifier. The generator creates nanobubbles in the absence of an external source of gas.

In some embodiments of the third aspect, the first energy source is configured to apply the oscillating magnetic field to the reduced pressure zone, and the second energy source is configured to apply the electrical arc to the reduced pressure zone. In some embodiments of the third aspect, the first energy source is configured to apply the oscillating magnetic field to a portion of the pipe upstream of the reduced pressure zone, a portion of the pipe downstream of the reduced pressure zone, or both, and the second energy source is configured to apply the electrical arc to the portion of the pipe upstream of the reduced pressure zone, the portion of the pipe downstream of the reduced pressure zone, or both.

The nanobubble generator creates nanobubbles in the absence of an external source of gas, thereby simplifying the apparatus by eliminating the need for a separate source of gas. By applying an oscillating magnetic field to the liquid as it flows through the reduced pressure zone, it is possible to create high concentrations of nanobubbles even when the pressure of the incoming liquid stream is low.

The apparatuses and methods described above can be used in a variety of applications. Examples include water treatment, e.g., wastewater treatment to remove contaminants in a body of water. Other examples include aquaculture and agriculture, where the composition can be used to enhance the delivery of nutrients or to remove biofilm from irrigation equipment and other surfaces. Yet another example is cleaning and sterilization, e.g., in hot tubs or spas to minimize or eliminate the use of chemicals such as chlorine.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a side view of an example apparatus for producing a composition comprising nanobubbles dispersed in a liquid carrier.

FIG. 1B is a cross-sectional side view of the apparatus of FIG. 1A.

FIG. 1C is a perspective view of the apparatus of FIG. 1A.

FIG. 1D is a cross-sectional perspective view of the apparatus of FIG. 1A.

FIG. 2A is a side view of an example apparatus for producing a composition comprising nanobubbles dispersed in a liquid carrier.

FIG. 2B is a cross-sectional side view of the apparatus of FIG. 2A.

FIG. 2C is a perspective view of the apparatus of FIG. 2A.

FIG. 2D is a cross-sectional perspective view of the apparatus of FIG. 2A.

FIG. 3A is a side view of an example apparatus for producing a composition comprising nanobubbles dispersed in a liquid carrier.

FIG. 3B is a cross-sectional side view of the apparatus of FIG. 3A.

FIG. 3C is a perspective view of the apparatus of FIG. 3A.

FIG. 3D is a cross-sectional perspective view of the apparatus of FIG. 3A.

FIG. 4 is a cross-sectional side view of an example apparatus for producing a composition comprising nanobubbles dispersed in a liquid carrier.

FIG. 5 is a cross-sectional side view of an example apparatus for producing a composition comprising nanobubbles dispersed in a liquid carrier.

FIG. 6 is a cross-sectional side view of an example apparatus for producing a composition comprising nanobubbles dispersed in a liquid carrier.

FIG. 7 is a cross-sectional side view of an example apparatus for producing a composition comprising nanobubbles dispersed in a liquid carrier.

FIG. 8 is a cross-sectional side view of an example apparatus for producing a composition comprising nanobubbles dispersed in a liquid carrier.

FIG. 9 is a cross-sectional side view of an example apparatus for producing a composition comprising nanobubbles dispersed in a liquid carrier.

Like reference symbols in the various drawings indicate like elements.

### DETAILED DESCRIPTION

This disclosure describes an apparatus for producing nanobubbles in a liquid carrier. The nanobubbles have diameters less than one micrometer (μm). In some embodiments, the nanobubbles have diameters less than or equal to 500 nanometers (nm). In some embodiments, the nanobubbles have diameters less than or equal to 200 nanometers (nm).

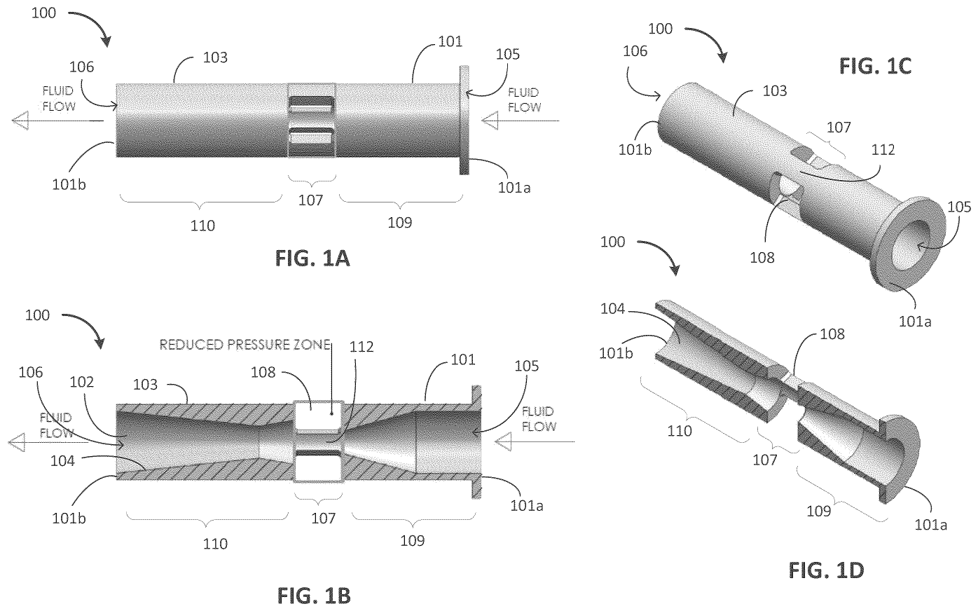

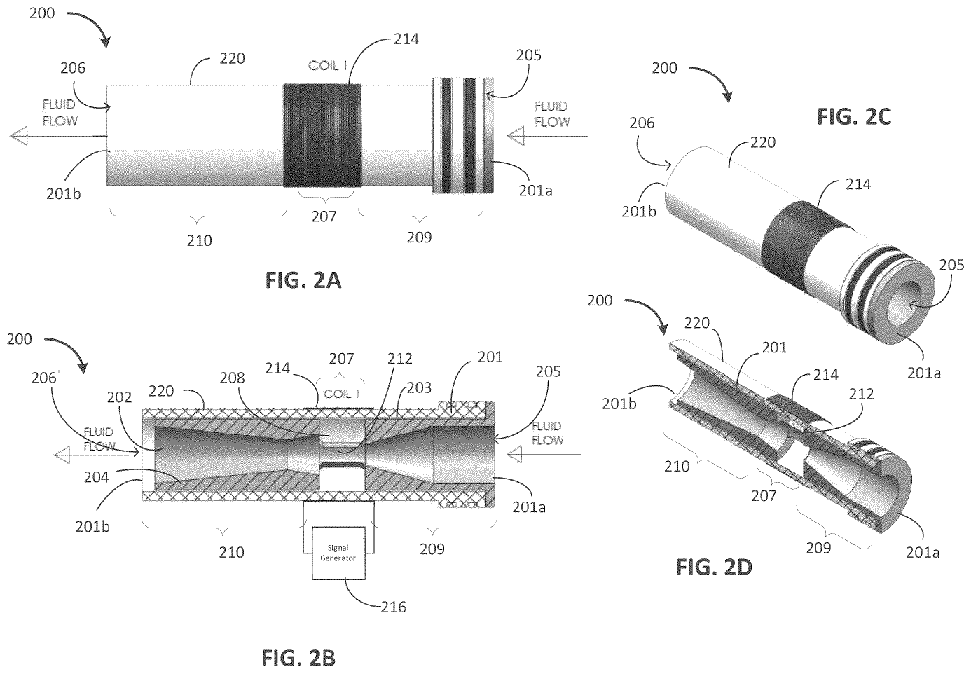

FIGS. 1A and 1B are schematic diagrams showing a side view and a cross-sectional view, respectively, of an exemplary apparatus 100 for creating a reduced pressure zone in a nanobubble producing apparatus (e.g., a nanobubble generator), which will be discussed and shown in subsequent sections and figures (e.g., FIGS. 2A-9). FIGS. 1C and 1D are schematic diagrams showing a perspective view and a cross-sectional perspective view, respectively, of the exemplary apparatus 100. The apparatus 100 includes a housing 101 defined by a first end 101a, a second end 101b, and an interior cavity 102 adapted for receiving a liquid carrier from a liquid source. The housing 101 including an external surface 103 and an internal surface defining the interior cavity 102. The housing 101 has a liquid inlet 105 at the first end 101a and a liquid outlet 106 at the second end 101b. The housing 101 can be an elongate housing forming a pipe. The interior cavity 102 is shaped and sized to create a reduced pressure zone 107 between the liquid inlet 105 and liquid outlet 106. As illustrated in FIGS. 1B and 1D, the internal surface 104 of the interior cavity 102 has a constriction between the first end 101a and the reduced pressure zone 107. The internal surface 104 of the interior cavity 102 also includes a constriction between the reduced pressure zone 107 and the second end 101b.

The internal surface 104 of the interior cavity 102 in the housing 101 is shaped and sized to create a reduced pressure zone 107 between the first end 101a and the second end 101b. The reduced pressure zone 107 includes a gap 108 between the first housing section 109 and the second housing section 110. The gap 108 between the first housing section 109 and the second housing section 110 is of a predetermined size. The gap is formed by the housing 101. In some implementations, the gap can be optionally defined by a bar 112 connecting a first housing section 109 to a second housing section 110.

The bar 112 controls the predetermined distance of the gap 108 between the first housing section 109 and a second housing section 110 that contributes to the reduction in fluid pressure in the reduced pressure zone 107. In some implementations, the apparatus 100 does not include a bar 112 between the first housing section 109 and the second housing section 110. In such cases, the first housing section 109 and the second housing section 110 can be positioned relative to one another by affixing the housing 101 to an outer pipe, enclosure, or mount. For example, a mount can serve to couple the first housing section 109 and the second housing section 110 together in the apparatus 100. In some implementations, rather than a gap 108, the housing includes one or more apertures formed as windows through the housing 101 extending from the internal surface 104 to the external surface 103.

The narrowing or constriction of the interior cavity 102 between the first end 101a and the reduced pressure zone 107, and between the second end 101b and the reduced pressure zone 107, produce a Venturi effect as liquid flows from the liquid inlet 105 through the narrowing in the interior cavity 102 to the reduced pressure zone 107. In some implementations, the constriction between the first end 101a and the reduced pressure zone 107 in the first housing section 109 forms a nozzle through which the fluid flow passes into the reduced pressure zone 107. Fluid flow through the gap 108 at the reduced pressure zone 107 into the second housing section 110 provides a suction of the fluid in the gap 108 to produce a vacuum pressure configured to vaporize at least a portion of the fluid flowing through the gap 108. As will be described below, nanobubbles are formed when one or more electrical conductors proximate the reduced pressure zone 107 generate an oscillating magnetic field over the reduced pressure zone 107, provide an electrical arc at the reduced pressure zone 107, or both. In some examples, the oscillating magnetic field is generated or the electric arc is provided over the first housing section 109 upstream of the reduced pressure zone 107, over the second housing section 110 downstream of the reduced pressure zone 107, or both. For instance, the oscillating magnetic field, electrical arc, or both interact with gas that is already dissolved in the fluid to generate nanobubbles in the fluid.

In some embodiments, the apparatus 100 is connected to a source of liquid that provides the liquid carrier (for example, water). In some embodiments, the source of liquid is a vessel or body of water connected to a pump via a suction line. In some embodiments, the pump is a variable speed pump. In some embodiments, the pump is connected to the apparatus 100 via a discharge line with a control valve. In some embodiments, the discharge line is in fluid communication with the housing 101. For example, the liquid carrier flows from the pump, through the control valve, through the discharge line, and to the first end 101a. The percent opening of the control valve can be adjusted to control the pressure and flow rate of the liquid carrier to the apparatus 100.

FIGS. 2A-D are schematic diagrams of an exemplary apparatus 200 for producing a composition comprising nanobubbles dispersed in a liquid carrier. The apparatus 200 includes a pressure-zone-reducing structure having one or more of the same features (e.g., housing 201, reduced pressure zone 207) that are similar or the same of those described above for apparatus 100 in FIGS. 1A-1D. The apparatus 200 includes an outer tube 220 surrounding the housing 201, and an electromagnetic coil 214.

The apparatus 200 is further connected to an energy source comprising a power supply, a signal generator, and at least one electrical conductor configured to apply an oscillating magnetic field to the housing 201, e.g., to the reduced pressure zone 207, to the first housing section 209 upstream of the reduced pressure zone 207, or to the second housing section 210 downstream of the reduced pressure zone. The apparatus 200 creates nanobubbles without an external gas source. As will be discussed in greater detail below, the electrical conductor can comprise one or more electrode pins, concentric electrodes, wires, and helicoidal members such as electromagnetic coils. The shape of the electrode can be of various forms, for example, the electrode can include a conductive surface that is flat, helicoidal, disc-shaped, spherical, trapezoidal or a combination thereof. The electrical conductor is configured to create an oscillating field in a reduced pressure zone such that the field is parallel and concentric to the flow of the fluid. Electrodes and electromagnetic coils can be used in combination or separately to provide an oscillating magnetic field and/or an electrical arc at the reduced pressure zone.

In some embodiments, the liquid carrier containing the nanobubbles formed by the apparatus 200 flows out of the apparatus 200 (for example, out of the second end 201b) to a discharge line. In some embodiments, the liquid carrier containing the nanobubbles formed by the apparatus 200 flows out of the apparatus 200 to multiple selectable discharge lines (for example, in a vessel or body of water).

As described above, the apparatus 200 can include the outer tube 220 to hold the first housing section 209 at a distance from the second housing section 210, creating a gap 208 in the housing 201. The electromagnetic coil 214 is positioned on the outer tube 220 over the reduced pressure zone 207. The electromagnetic coil 214 is coupled to a power supply and signal generator 216. The electromagnetic coil 214 provides a magnetic flux parallel to the fluid flow at the reduced pressure zone 207. In some implementations, the electromagnetic coil 214 provides an oscillating magnetic field to the reduced pressure zone 207. In some implementations, the electromagnetic coil 214 is positioned to provide magnetic flux at the second housing section 210. While the electromagnetic coil 214 is positioned on the outer tube 220, in some implementations the electromagnetic coil 214 is positioned within the outer tube 220. In some implementations, the electromagnetic coil 214 is positioned about the external surface of the housing 201 or within the housing 201.

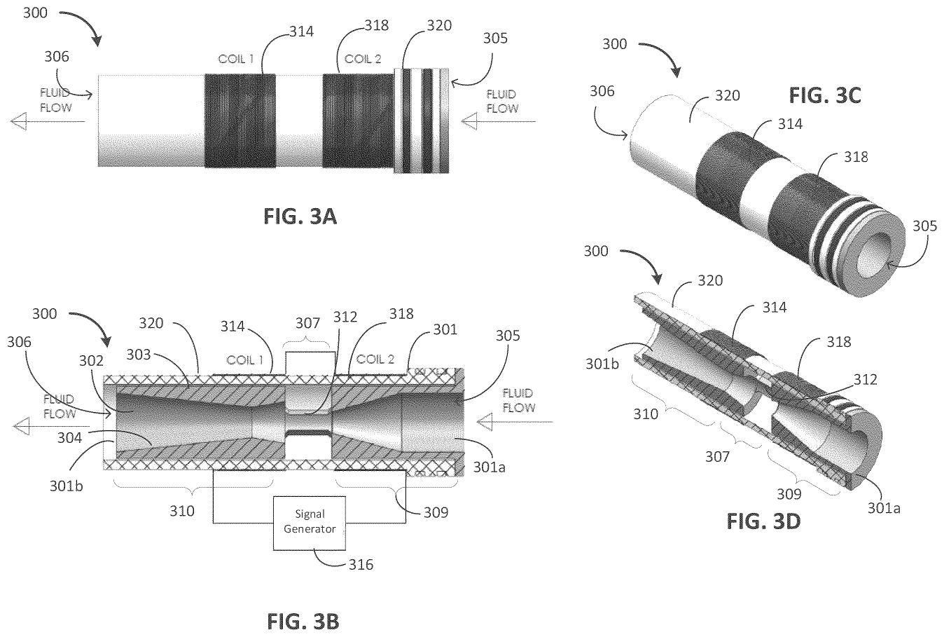

FIGS. 3A-D are diagrams of an exemplary apparatus 300, which includes one or more of the same features as FIGS. 1A-D and 2A-D, with an additional electromagnetic coil 318. Apparatus 300 includes a first electromagnetic coil 314 and a second electromagnetic coil 318 positioned on the outer tube 320. The first electromagnetic coil 314 is positioned to one side of the reduced pressure zone 307 toward the fluid outlet 306, and the second electromagnetic coil 318 is positioned at the opposite side of the reduced pressure zone 307 toward the fluid inlet 305. The first electromagnetic coil 314 and the second electromagnetic coil 318 are coupled to the power supply and signal generator 316. When power is supplied to the first electromagnetic coil 314 and the second electromagnetic coil 318, the first electromagnetic coil 314 and the second electromagnetic coil 318 provide oscillating magnetic fields that overlap over the housing 301, e.g., over the reduced pressure zone 307, over the first housing section 309 upstream of the reduced pressure zone 307, or over the second housing section 310 downstream of the reduced pressure zone. For instance, the first electromagnetic coil 314 and the second electromagnetic coil 318 are arranged such that the oscillating magnetic fields converge on the housing, e.g., on the reduced pressure zone 307. While the first electromagnetic coil 314 and the second electromagnetic coil 318 are each positioned on the outer tube 320, in some implementations the first electromagnetic coil 314 and the second electromagnetic coil 318 are each positioned within the outer tube 320. In some implementations, the first electromagnetic coil 314 and the second electromagnetic coil 318 are positioned about the external surface of the housing 301 or within the housing 301. In some implementations, a portion of one or both of the first electromagnetic coil 314 and the second electromagnetic coil 318 extends over a portion of the reduced pressure zone 307.

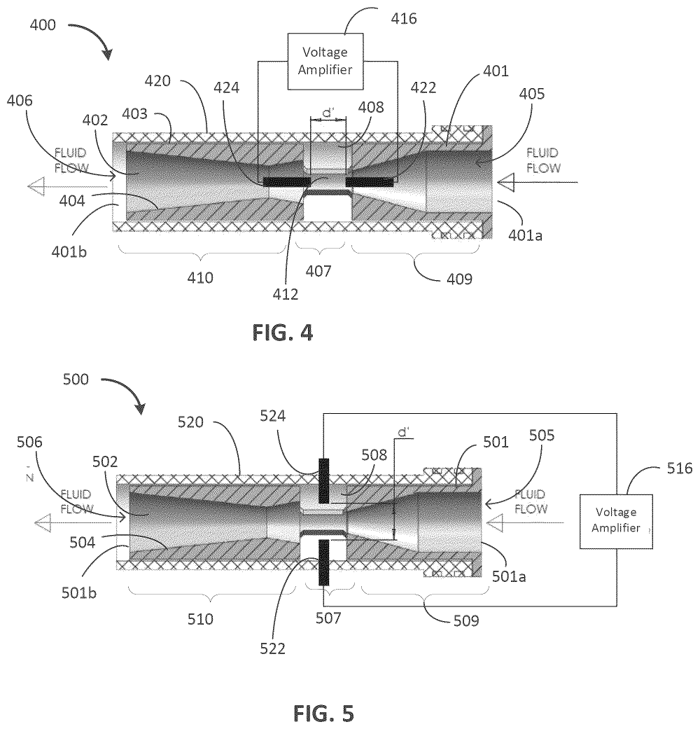

FIG. 4 shows another exemplary apparatus 400. While apparatus 400 includes some same features (e.g., outer tube 420, reduced pressure zone 407) of previously discussed apparatuses (e.g., apparatuses 100, 200, 300), this section focuses on the distinctions present in apparatus 400. For example, apparatus 400 includes a first electrode 422 and a second electrode 424 positioned in the flow path through the cavity 402 on either side of the gap 408 forming the reduced pressure zone 407. The first electrode 422 is adjacent the gap 408 and positioned toward the fluid inlet 405, and the second electrode 424 is adjacent the gap 408 and positioned toward the fluid outlet 406. The first electrode 422 and the second electrode 424 are coupled to the power supply and voltage amplifier 416. In some examples, the first and second electrode 422, 424 are coupled to a power supply without an amplifier. The first electrode 422 and the second electrode 424 generate an electrical arc and apply the electrical arc across the gap 408 at the reduced pressure zone 407, at the first housing section 409 upstream of the reduced pressure zone 407, or to the second housing section 410 downstream of the reduced pressure zone. In some implementations, the first electrode 422 and the second electrode 424 produce a plasma. The electrical arc can travel in a first direction from the first electrode 422 to the second electrode 424, a second direction from the second electrode 424 to the first electrode 422, or with alternating directionality over time.

The first electrode 422 and the second electrode 424 can each have a length and thickness. In some implementations, the length and/or thickness of the first electrode 422 differs from that of the second electrode 424. The first electrode 422 and the second electrode 424 are separated from one another by a distance d′ in the direction of fluid flow. In some implementations, the distance separating the first electrode 422 from the second electrode 424 is a same distance as the length of the gap 408 between the first housing section 409 and the second housing section 410. In some implementations, the distance separating the first electrode 422 from the second electrode 424 is less than the length of the gap 408 between the first housing section 409 and the second housing section 410. In some implementations, the distance separating the first electrode 422 from the second electrode 424 is a greater than the length of the gap 408 between the first housing section 409 and the second housing section 410. In some implementations, the first electrode 422 and the second electrode 424 are positioned in a center of the housing 401 along a longitudinal axis equidistant from all internal surfaces 404 of the internal cavity 402. In some implementations, the first electrode 422 and the second electrode 424 are offset from a center of the housing 401. In some implementations, the first electrode 422 and the second electrode 424 are formed as electrode pins pointing at each other in or across the reduced pressure zone 407. In some implementations, the first electrode 422 and the second electrode 424 are offset with respect to the reduced pressure zone 407 so as to generate an electrical arc within the first housing section 409 or the second housing section 410, rather than across or in the reduced pressure zone 407. In some implementations, at least one of the first electrode 422 from the second electrode 424 is positioned on the external surface 404 of the housing 401. In some implementations, at least one of the first electrode 422 from the second electrode 424 is positioned on the internal surface 404 of the housing 401. In some examples, the housing 401 itself is the first electrode 422 or the second electrode 424.

FIG. 5 shows another exemplary apparatus 500. Apparatus 500 includes some of the same features (e.g., first electrode 522 and second electrode 524) of previously discussed apparatuses (e.g., apparatus 400), this section focuses on the distinctions present in apparatus 500. For example, the first electrode 522 and second electrode 524 are positioned transverse to the direction of flow in apparatus 500. The first electrode 522 is positioned transverse to the direction of flow and to a longitudinal axis of the housing 501, and extends into the gap 508 at the reduced pressure zone 507. The second electrode 524 is positioned opposite from the first electrode 522 transverse to the direction of flow and to the longitudinal axis of the housing 501, and extending into the gap 508 at the reduced pressure zone 507. The first electrode 522 and second electrode 524 are coupled to a power supply and voltage amplifier 516. In some examples, the first and second electrode 522, 524 are coupled to a power supply without an amplifier.

The first electrode 522 and the second electrode 524 can each have a length and thickness. In some implementations, the length and/or thickness of the first electrode 522 differs from that of the second electrode 524. The first electrode 522 and the second electrode 524 are separated from one another by a distance measured transversely to the direction of fluid flow. In some implementations, the first electrode 522 and the second electrode 524 are oriented at 90 degrees from the fluid flow direction. In some implementations, a distance separating the first electrode 522 from the second electrode 524 is a same distance as a diameter of the housing 501 adjacent to the reduced pressure zone 507. In some implementations, the distance separating the first electrode 522 from the second electrode 524 is a less than the diameter of the housing 501 adjacent to the reduced pressure zone 507. In some implementations, the first electrode 522 and the second electrode 524 are positioned at a midpoint of the gap 508 between the first housing section 509 and the second housing section 510. In some implementations, the first electrode 522 and the second electrode 524 are offset from the midpoint of the gap 508 between the first housing section 509 and the second housing section 510.

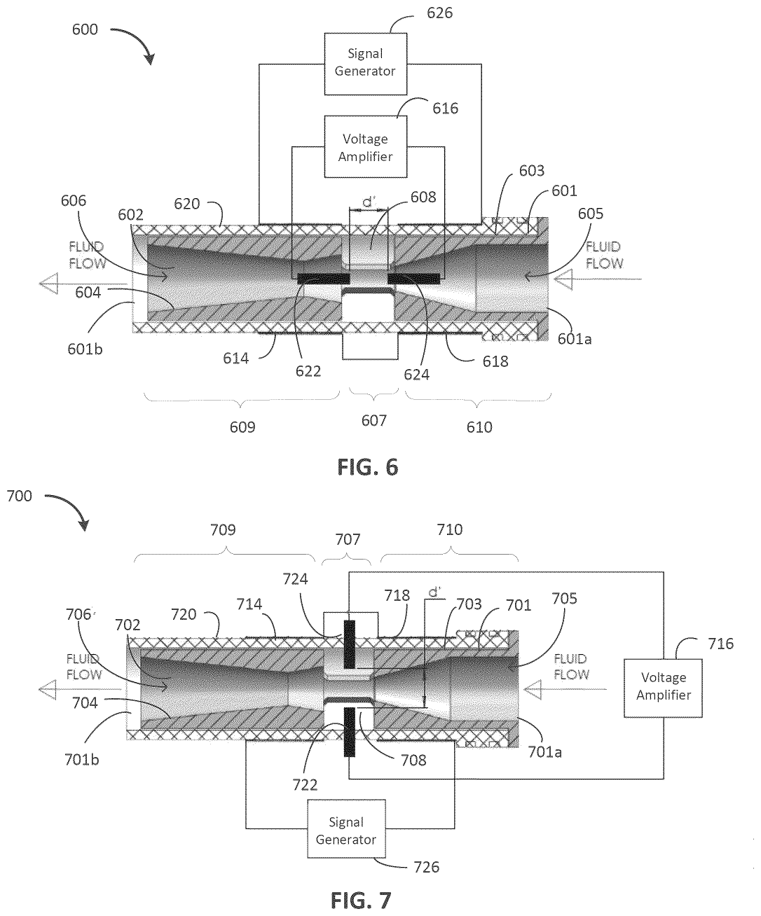

FIG. 6 shows another exemplary apparatus 600. Apparatus 600 includes some of the same features (e.g., outer tube 620, reduced pressure zone 607) of previously discussed apparatuses (e.g., apparatuses 100, 200, 300, 400, 500), this section focuses on the distinctions present in apparatus 600. For example, apparatus 600 includes a first electrode 622 and a second electrode 624, and a first electromagnetic coil 614 and a second electromagnetic coil 618. The first electrode 622 and the second electrode 624 are oriented in the direction of fluid flow through the cavity 602 from the fluid inlet 605 to the fluid outlet 606. The first electrode 622 and the second electrode 624 are coupled to a first power supply and voltage amplifier 616. In some examples, the first and second electrode 622, 624 are coupled to a power supply without an amplifier.

The first electromagnetic coil 614 and the second electromagnetic coil 618 are positioned about the outer tube 620 on either side of the gap 608 at the reduced pressure zone 607, and are coupled to a second power supply and signal generator 626. While the first electromagnetic coil 614 and the second electromagnetic coil 618 are each positioned on the outer tube 620, in some implementations the first electromagnetic coil 614 and the second electromagnetic coil 618 are each positioned within the outer tube 620 about the external surface 603 of the housing 601. In some implementations, a portion of one or both of the first electromagnetic coil 614 and the second electromagnetic coil 618 extends over a portion of the reduced pressure zone 607. In some implementations, during use of the apparatus 600 the first electrode 622 and the second electrode 624 produce an electrical arc at the reduced pressure zone 607, and the first electromagnetic coil 614 and the second electromagnetic coil 618 produce oscillating magnetic fields that overlap and combine at the housing 601, e.g., at the reduced pressure zone 607. In some examples, the electric arc is provided at one or both of the first or second housing sections 609, 610, or the oscillating magnetic fields overlap and combine at one or both of the first or second housing sections 609, 610. For instance, the first electromagnetic coil 614 and the second electromagnetic coil 618 are arranged such that the oscillating magnetic fields converge on the housing, e.g., on the reduced pressure zone 607. In some implementations, the apparatus 600 includes a switch (not shown) allowing the selection of the first electrode 622 and the second electrode 624 or the first electromagnetic coil 614 and the second electromagnetic coil 618 as a mechanism for producing nanobubbles. In some implementations, the apparatus 600 can include the first electrode 622 and the second electrode 624 and a single electromagnetic coil, and the electrodes and electromagnetic coil can be used separately or in combination to produce nanobubbles.

FIG. 7 shows another exemplary apparatus 700. Apparatus 700 includes some of the same features (e.g., first electrode 722 and second electrode 724, first electromagnetic coil 714 and second electromagnetic coil 718) of previously discussed apparatuses (e.g., apparatus 600), this section focuses on the distinctions present in apparatus 700. For example, apparatus 700 includes a first electrode 722 and a second electrode 724, each positioned transverse to the direction of flow through the cavity 702 and transverse to a longitudinal axis of the housing 701. Each of the first electrode 722 and the second electrode 724 extends into the gap 708 at the reduced pressure zone 707.

The apparatus 700 also includes a first electromagnetic coil 714 and a second electromagnetic coil 718. The first electrode 722 and the second electrode 724 are coupled to a first power supply and voltage amplifier 716, and the first electromagnetic coil 714 and the second electromagnetic coil 718 are coupled to a second power supply and signal generator 726. In some examples, the first and second electrode 722, 724 are coupled to a first power supply without an amplifier. While the first electromagnetic coil 714 and the second electromagnetic coil 718 are each positioned on the outer tube 720, in some implementations the first electromagnetic coil 714 and the second electromagnetic coil 718 are each positioned within the outer tube 720 about the external surface 703 of the housing 701. In some implementations, a portion of one or both of the first electromagnetic coil 714 and the second electromagnetic coil 718 extends over a portion of the reduced pressure zone 707. As described above, the first electrode 722 and a second electrode 724 can be used in combination with the first electromagnetic coil 714 and the second electromagnetic coil 718, or the apparatus 700 can include a switch for selection of a mechanism using the electrodes or the coils separately. In some implementations, the apparatus 700 can include the first electrode 722 and the second electrode 724 and a single electromagnetic coil, and the electrodes and electromagnetic coil can be used separately or in combination to produce nanobubbles.

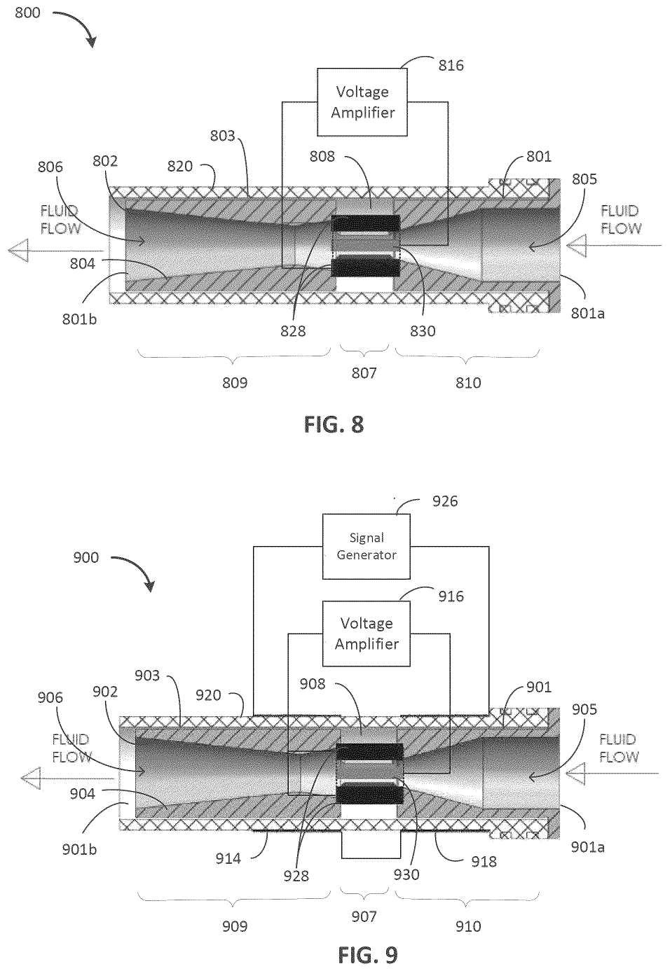

FIG. 8 shows another exemplary apparatus 800. Apparatus 800 includes some of the same features (e.g., outer tube 820, reduced pressure zone 807) of previously discussed apparatuses (e.g., apparatuses 100, 200, 300, 400, 500, 600, 700), and this section focuses on the distinctions present in apparatus 800. For example, apparatus 800 includes outer concentric electrode 828 that is tubular in shape and inner concentric electrode 830 positioned within the housing 801. The inner concentric electrode 830 is positioned at a center of the housing 801 extending across the gap 808 in the reduced pressure zone 807. The outer concentric electrode 828 extends around the inner concentric electrode 830 and is positioned within the housing 801 and across the gap 808 in the reduced pressure zone 807. In some implementations, at least one of the inner concentric electrode 830 and the outer concentric electrode 828 is positioned in contact with the external surface 804 of the housing 801. In some implementations, at least one of the inner concentric electrode 830 and the outer concentric electrode 828 is positioned in contact with the internal surface 804 of the housing 801.

The inner concentric electrode 830 and the outer concentric electrode 828 are coupled to a power supply and voltage amplifier 816. In some examples, the inner and outer concentric electrodes 830, 828 are coupled to a power supply without an amplifier. In use, the inner concentric electrode 830 and the outer concentric electrode 828 generate an electrical arc at the reduced pressure zone 807 or at one or both of the first or second housing sections 809, 810.

FIG. 9 shows another exemplary apparatus 900. Apparatus 900 includes some of the same features (e.g., outer tube 920, reduced pressure zone 907, inner concentric electrode 930 and outer concentric electrode 928) of previously discussed apparatuses (e.g., apparatuses 100, 200, 300, 400, 500, 600, 700, 800), and this section focuses on the distinctions present in apparatus 900. For example, apparatus 900 includes a first electromagnetic coil 914 and a second electromagnetic coil 918 in combination with the inner concentric electrode 930 and outer concentric electrode 928.

The inner concentric electrode 930 is positioned at a center of the housing 901 extending across the gap 908 in the reduced pressure zone 907. The outer concentric electrode 928 extends around the inner concentric electrode 930 and is positioned within the housing 907 and across the gap 908 in the reduced pressure zone 907. The inner concentric electrode 930 and the outer concentric electrode 928 are coupled to a power supply and voltage amplifier 916. In some examples, the inner and outer concentric electrodes 930, 928 are coupled to a power supply without an amplifier. In use, the inner concentric electrode 930 and the outer concentric electrode 928 generate an electrical arc at the reduced pressure zone 907 or at one or both of the first or second housing sections 909, 910.

The first electromagnetic coil 914 and the second electromagnetic coil 918 are coupled to a second power supply and signal generator 926. In use, the first electromagnetic coil 914 and the second electromagnetic coil 918 each provide an oscillating magnetic field that overlaps and combines at the housing 901, e.g., at the reduced pressure zone 907 or at one or both of the first or second housing sections 909, 910. For instance, the first electromagnetic coil 914 and the second electromagnetic coil 918 are arranged such that the oscillating magnetic fields converge on the housing, e.g., on the reduced pressure zone 907. While the first electromagnetic coil 914 and the second electromagnetic coil 918 are each positioned on the outer tube 920, in some implementations the first electromagnetic coil 914 and the second electromagnetic coil 918 are each positioned within the outer tube 920 about the external surface 903 of the housing 901. In some implementations, a portion of one or both of the first electromagnetic coil 914 and the second electromagnetic coil 918 extends over a portion of the reduced pressure zone 907. The inner concentric electrode 930 and the outer concentric electrode 928 can be used in combination with the first electromagnetic coil 914 and the second electromagnetic coil 918, or the apparatus 900 can include a switch for selecting between the electrodes and coils. In some implementations, the apparatus 600 can include the inner concentric electrode 930 and the outer concentric electrode 928 and a single electromagnetic coil, and the electrodes and electromagnetic coil can be used separately or in combination to produce nanobubbles.

As described above in FIGS. 2A-D, and 3-9, the electrical conductor can comprise one or more electrode pins, concentric electrodes, and electromagnetic coils. Electrodes and electromagnetic coils can be used in combination or separately to provide an electrical current and/or magnetic field at the reduced pressure zone. In some implementations, a stator can be used as an electrical conductor as an alternative to or in combination with one or more electromagnetic coils. In some implementations, one or more pin electrodes positioned within the housing or across the housing transverse to the direction of flow can be replaced with one or more wires within the flow path.

A method for producing a composition including nanobubbles dispersed in a liquid carrier using any of the apparatuses described above includes introducing a liquid carrier from a liquid source into the interior cavity of the housing through the liquid inlet of the housing, and applying an oscillating magnetic field or electrical arc across the reduced pressure zone of the housing using one or more electrical conductors as liquid flows from the liquid inlet to the liquid outlet of the housing. The application of the oscillating magnetic field or electrical arc across the reduced pressure zone while liquid flows through the housing produces nanobubbles in the absence of an external source of gas. Creating nanobubbles in the absence of an external source of gas, simplifies the apparatus by eliminating the need for a separate source of gas. By applying an oscillating magnetic field and/or electrical arc to the liquid as it flows through the reduced pressure zone, it is possible to create high concentrations of nanobubbles even when the pressure of the incoming liquid stream is low.

A number of embodiments of the invention have been described. Nevertheless, it will be understood that various modifications may be made without departing from the spirit and scope of the invention. Accordingly, other embodiments are within the scope of the following claims.

What is claimed is:

1. A nanobubble generator comprising:
(a) a pipe comprising an external surface, an internal surface, an internal cavity through which liquid can flow, a liquid inlet, and a liquid outlet, the internal cavity being configured to create a reduced pressure zone between the liquid inlet and liquid outlet; and
(b) an energy source comprising a power supply, a signal generator, and at least one electrical conductor configured to apply an oscillating magnetic field to the pipe,
wherein the generator creates nanobubbles in the absence of an external source of gas.

2. The nanobubble generator of claim 1, wherein the electrical conductor is configured to apply the oscillating magnetic field to the reduced pressure zone.

3. The nanobubble generator of claim 1, wherein the electrical conductor is configured to apply the oscillating magnetic field to a portion of the pipe upstream of the reduced pressure zone, a portion of the pipe downstream of the reduced pressure zone, or both.

4. The nanobubble generator of claim 1, wherein the electrical conductor is positioned on the external surface of the pipe.

5. The nanobubble generator of claim 1, wherein the electrical conductor is positioned on the internal surface of the pipe.

6. The nanobubble generator of claim 1, wherein the electrical conductor comprises a magnetic coil.

7. The nanobubble generator of claim 1, wherein the electrical conductor comprises a stator.

8. The nanobubble generator of claim 1, wherein the electrical conductor comprises a wire.

9. The nanobubble generator of claim 1, wherein the energy source comprises a pair of magnetic coils configured to generate oscillating magnetic fields that overlap at the pipe.

10. The nanobubble generator of claim 9, wherein the energy source comprises four magnetic coils.

11. The nanobubble generator of claim 1, wherein the energy source comprises a pair of magnetic coils configured to generate oscillating magnetic fields, wherein the magnetic fields converge at the pipe.

12. A nanobubble generator comprising:
(a) a pipe comprising an external surface, an internal surface, an internal cavity through which liquid can flow, a liquid inlet, and a liquid outlet, the internal cavity being configured to create a reduced pressure zone between the liquid inlet and liquid outlet; and
(b) an energy source comprising a power supply and a pair of electrical conductors configured to generate an electrical arc between the two electrical conductors and apply the electrical arc to the pipe,
wherein the generator creates nanobubbles in the absence of an external source of gas.

13. The nanobubble generator of claim 12, wherein the energy source is configured to apply the electrical arc to the reduced pressure zone.

14. The nanobubble generator of claim 12, wherein the energy source is configured to apply the electrical arc to a portion of the pipe upstream of the reduced pressure zone, a portion of the pipe downstream of the reduced pressure zone, or both.

15. The nanobubble generator of claim 12, wherein at least one of the electrical conductors is positioned on the external surface of the pipe.

16. The nanobubble generator of claim 12, wherein at least one of the electrical conductors is the pipe.

17. The nanobubble generator of claim 12, wherein at least one of the electrical conductors is positioned on the internal surface of the pipe.

18. The nanobubble generator of claim 12, wherein at least one of the electrical conductors comprises a wire.

19. A nanobubble generator comprising:
(a) a pipe comprising an external surface, an internal surface, an internal cavity through which liquid can flow, a liquid inlet, and a liquid outlet, the internal cavity being configured to create a reduced pressure zone between the liquid inlet and liquid outlet; and
(b) a first energy source comprising a power supply, a signal generator, and at least one electrical conductor configured to apply an oscillating magnetic field to the pipe; and
(c) a second energy source comprising a power supply and a pair of electrical conductors configured to generate an electrical arc between the two electrical conductors and apply the electrical arc to the pipe,
wherein the generator creates nanobubbles in the absence of an external source of gas.

20. The nanobubble generator of claim 19, wherein:
the first energy source is configured to apply the oscillating magnetic field to the reduced pressure zone, and
the second energy source is configured to apply the electrical arc to the reduced pressure zone.

21. The nanobubble generator of claim 19, wherein:
the first energy source is configured to apply the oscillating magnetic field to a portion of the pipe upstream of the reduced pressure zone, a portion of the pipe downstream of the reduced pressure zone, or both, and
the second energy source is configured to apply the electrical arc to the portion of the pipe upstream of the reduced pressure zone, the portion of the pipe downstream of the reduced pressure zone, or both.

22. The nanobubble generator of claim 19, wherein the electrical conductor, the pair of electrical conductors, or both, are positioned on the external surface of the pipe.

23. The nanobubble generator of claim 19, wherein the electrical conductor or one of the pair of electrical conductors is the pipe.

24. The nanobubble generator of claim 19, wherein the electrical conductor, the pair of electrical conductors, or both, are positioned on the internal surface of the pipe.

25. The nanobubble generator of claim 19, wherein the electrical conductor comprises a magnetic coil.

26. The nanobubble generator of claim 19, wherein the electrical conductor comprises a stator.

27. The nanobubble generator of claim 19, wherein the electrical conductor, the pair of electrical conductors, or both, comprise a wire.

28. The nanobubble generator of claim 19, wherein the first energy source comprises a pair of magnetic coils configured to generate oscillating magnetic fields that overlap at the pipe.

29. The nanobubble generator of claim 19, wherein the first energy source comprises a pair of magnetic coils configured to generate oscillating magnetic fields, wherein the magnetic fields converge at the pipe.
